(19) United States
(12) Patent Application Publication
(10) Pub. No.: US 2012/0322938 A1
(43) Pub. Date: Dec. 20, 2012

(54) Composition Of Secondary Amine Adducts, Amine Diluents and Polyisocyanates

(76) Inventor: Ling TAN, Raleigh, NC (US)

(21) Appl. No.: 13/523,321

(22) Filed: Jun. 14, 2012

(30) Foreign Application Priority Data
Jun. 15, 2011 (CN) 201110166523.X

(51) Int. Cl. C09D 175/12

(52) U.S. Cl. 524/538

(57) ABSTRACT

A composition suitable for forming a paint marking on a roadway comprises a secondary amine adduct having at least two secondary amine groups, an amine diluent and a polyisocyanate. The secondary amine adduct and the amine diluent react with the polyisocyanate to yield a chemically high crosslinked material having a no track time of about two minutes.

### FIELD OF THE INVENTION

The invention relates to polymeric compositions that may be used in pavement marking, paint and adhesive applications.

### BACKGROUND OF THE INVENTION

There has been recent activity surrounding the development of polymeric compositions that may be used, for example, in road- or pavement-marking applications. Due to the surface and ambient conditions under which the paint is subjected, it is desirable that the paint composition meet a number of requirements. These requirements include, for example, adhesion to road surfaces, resistance to chemical attack by water and/or salt, abrasion resistance, minimal hazard involving any processing solvents, ability to adhere to or hold or retain a glass bead filler or overcoating, long-term weather resistance, ability to be applied under a wide variety of ambient temperature and road surface conditions, flowability or sprayability, good wetting action with respect to roadway surfaces, and flexibility (i.e., the ability to move as road surfaces expand or contract).

A number of materials have been proposed for road surface paint compositions. For example, U.S. Pat. No. 4,185,132 to Gurney proposes the use of co-curative materials, namely a cycloaliphatic amine and an aliphatic amine, in combination with a liquid epoxide. The above mixture is applied to the paved surface, and the mixture cures in-situ. U.S. Pat. No. 4,105,808 to McKenzie proposes a paint composition for application at elevated temperatures on traffic roadways. The composition includes a paint vehicle having a nonvolatile organic film-forming binder and a volatile solvent in which the binder is dissolved. McKenzie alleges that the above mixture forms a non-tacky paint film when applied as a thin coating and exposed to ambient temperatures. U.S. Pat. No. 4,460,625 to Emmons et al. proposes coating and impregnating compositions for applications to concrete which include several monomers, a polyvalent metal salt or complex, and an organic peroxide. U.S. Pat. No. 4,051,195 to McWhorter proposes curable compostions formed from epoxide resin/polyacrylate ester or polymethacrylate ester compositions.

Notwithstanding the above developments, these compositions often cure in a relatively slow time period. As an example, the tack free time is typically more than 60 minutes during which time the road must be blocked to apply the paint. The lengthy delay is particularly troublesome in view of the increasing traffic volume in high growth regions. Moreover, the durability of this paint is believed to be limited.

In the past two decades, a number of polyurea products were developed for the highway pavement marking. U.S. Pat. No. 6,369,189 to Reichhold proposes for a composition which has been commercialized to use in the pavement marking, hereby tested in Example 6, shows yellowing with a yellow index of 12 after 1000 hours accelerating weathering test, and an other commercial polyurea product made with the aspartic esters based on U.S. Pat. No. 5,243,012 have compellability application issue due to the physical mixing with glass bubbles.

Notwithstanding the above developments, these compositions have not provided a system that is fast curing, and with excellent weathering resistance, and friendly application for the pavement marking.

Thus, there is a need in the art for a traffic paint compositions which are fast curing, exhibit greater durability and smooth application.

### SUMMARY OF THE INVENTION

The present invention addresses the shortcomings alluded to above, and provides a polymeric composition for use in traffic paint exhibiting a fast cure rate as defined in greater detail herein below. The composition comprises a secondary amine adduct having at least two secondary amine groups, an amine diluent and a polyisocyanate. Advantageously, the secondary amine adduct component and an amine diluent to react with said polyisocyanate component that a chemically high crosslinked polymeric material is formed. The composition exhibits improved properties over conventional compositions, particularly two component urea system, in that the composition of the invention displays improved cure speed, improved durability, weathering resistance and different mix ratio application capability achieved by the changes of amine hydrogen equivalent weight with the secondary amine adduct component.

The polymeric composition may be employed in a traffic paint composition. The traffic paint composition comprises the polymeric composition and a pigment.

### BRIEF DESCRIPTION OF THE DRAWINGS

The reaction scheme in accordance with the method of the invention is illustrated below.

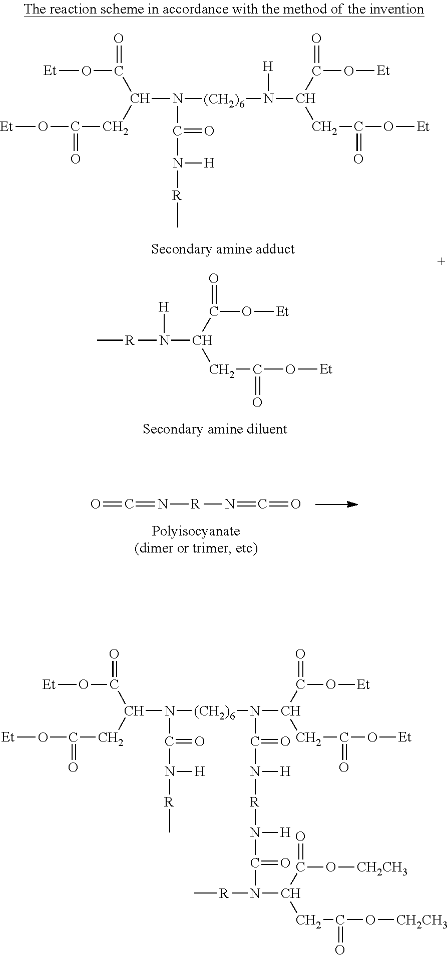

### DETAILED DESCRIPTION OF THE PREFERRED EMBODIMENTS

The invention will now be described in greater detail with reference to the preferred embodiments which follow. It should be appreciated, however, that these embodiments are for illustrative purposes only, and are not meant to limit the invention as defined by the claims.

As alluded to hereinabove, the invention refers to a polymeric composition that exhibits a fast cure rate. For the purposes of the invention, the term “fast cure rate” may be defined according to various measuring methods. In one instance, a fast cure rate may be defined by the term “no track time” which refers to the time necessary for the composition to cure on a road or other surface to the extent that no wheel tracks are left after the composition has been contacted by a vehicle. A preferred “no track time” is less than about 5 minutes, more preferably less than about 2 minutes, and most preferably less than or equal to about 1.5 minutes. In another instance, the term “through cure” refers to the time necessary for the composition (e.g., film) to develop hardness or integrity from a surface to a substrate. A preferred “through cure” time is less than about 5 minutes, and more preferably about 3 minutes. In yet another instance, the term “tack free time” refers to the time necessary for a composition in the form of a film to develop a hard surface. Preferably, the “tack free time” is less than about 5 minutes and is more preferably about 3 minutes.

The secondary amine adduct component in the polymeric composition of the invention may be selected from those materials which are known in the art. Typically, the secondary amine adduct component is a reaction product of a secondary amine and an aliphatic isocyanate or an epoxy functional component.

Examples of secondary amine include, but are not limited to, polyaspartic ester based on hexamethylene diamine, isophorone diamine, Bis(4-aminocyclohexyl)methane, and mixtures thereof.

A particularly preferred polyaspartic ester is polyaspartic ester based on hexamethylene diamine. Mixtures of the above may be employed.

Examples of aliphatic isocyanates that may be employed include, but are not limited to, isophoronediisocyanate, 1,1′-methylenebis(4-isocyantocyclohexane), hexamethyenediisocyanate, trimethyl-hexamethylenediisocyanate, biuret of isophoronediisocyanate, isocyanuratetrimer of isophoronediisocyanate, biuret of hexamethylenediisocyanate, isocyanuratetrimer of hexamethylenediisocycanate, prepolymers based on isophoronediisocyanate and trimethylol propane, prepolymers of isophoronediisocyanate and pentaerythritol, and prepolymers of isophoronediisocyanate and hexane diol. Mixtures of the above may be employed. In general, the aliphatic isocyanate can either be a monomeric component or may be a material that is chain extended by a polyhydric alcohol that may include, but is not limited to, diols, triols, and tetraols that are known to one skilled in the art. Examples of alcohols include, but are not limited to, ethylene glycol, diethylene glycol, trimethylol propane, trimethylol ethane, pentaerythritol, ethoxylatedpentaerythritol, and propoxylatedpentaerythritol. The polyol may be in the form of a polyester polyol or a polyether polyol such as, but not limited to, polypropylene glycol or polyethylene glycol or a combination of both.

Particularly preferred aliphatic isocyanates are isophoronediisocyanate and isocyanuratetrimer of hexamethylenediisocycanate. Mixtures of any of the above may be employed.

Examples epoxy functional component include, but are not limited to, bisphenol A diglycidyl ether, ethylene glycol diglycidyl ether, Neopentyl glycol diglycidyl ether, trimethylopropane triglycidyl ether, trimethylolethane triglycidyl ether, and mixtures thereof.

A particularly preferred epoxy functional component is trimethylopropane triglycidyl ether. Mixtures of the above may be employed.

The secondary amine adduct component used in the invention preferably contains two or more secondary amine functionalities, and more preferably three or more secondary amine functionalities.

The polymeric composition preferably comprises from about 5 to about 60 parts per weight of the secondary amine adduct component, and more preferably more from about 10 to about 50 parts by weight of this component. These percentages are based on the weight of the reactive components.

The amine diluent component that is employed in the invention may be selected from a number of amine compounds that are known in the art.

For the purposes of the invention, the amine diluent component may be selected from the polyaspartic esters based on hexamethylene diamine, isophorone diamine, Bis(4-aminocyclohexyl)methane, polypropylene glycol monoamine, and mixtures thereof. Preferably, the amine diluent component has from about 1 to about 2 secondary amine groups per molecule, and more preferably, from about 2 secondary amine groups per molecule.

The polymeric composition may comprise various amounts of the amine diluent component. Preferably, the composition comprises from about 10 to about 60 weight percent of the amine diluent component, and more preferably from about 20 to about 50 weight percent. These amounts are based on the total weight of reactive components.

As set forth herein, the polymeric composition of the invention comprises a polyisocyanate component. The polyisocyanate preferably is an aliphatic polyisocyanate. The polyisocyanate preferably has at least two isocyanate groups per molecule. Exemplary polyisocyanates include, but are not limited to, isophoronediisocyanate, 1,1′-methylenebis(4-isocyantocyclohexane), hexamethyenediisocyanate, trimethyl-hexamethylenediisocyanate, biuret of isophoronediisocyanate, isocyanuratetrimer of isophoronediisocyanate, biuret of hexamethylenediisocyanate, isocyanuratetrimer of hexamethylenediisocycanate, and the like. Mixtures of any of the above may be employed. Preferably, the polyisocyanate is used in the polymeric composition an amount from about 10 to about 50 weight percent, and more preferably from about 20 to about 35 weight percent. These weight percentages are based on the total weight of reactive components.

In accordance with the invention, the secondary amine adduct may also be used to increase the amine hydrogen equivalent weight of the component A so that a practical mixing ratio of the components is possible, for example 2 parts of a component A (i.e., a secondary amine adduct component and an amine diluent component) to 1 part of a component B (i.e., a polyfunctional isocyanate) by volume. Moreover, the secondary amine adduct may improve the compatibility of the component A and component B that potentially results in films with improved appearance, and overspray is limited.

The polymeric composition of the invention is typically utilized in conjunction with a paint composition, although other uses are contemplated within the scope of the invention. The paint composition may employ those components, additives, and the like which are known to the skilled artisan. Examples of materials that are typically employed in traffic paint compositions are set forth in U.S. Pat. No. 4,105,808 to McKenzie, the disclosure of which is incorporated herein by reference in its entirety. In particular, the paint composition comprises pigments such that the paint is visible after being applied to the pavement. Typically, white or yellow pigment is employed in the composition, preferably in an amount ranging from about 15 to about 25 parts based on the weight of the composition.

In another aspect, the invention relates to a method of forming a paint marking on a roadway. The method comprises applying a traffic paint composition comprising the polymeric composition as defined herein to the surface of a roadway. The method is advantageous in that it may be used utilizing existing equipment under ambient conditions.

A preferred method for carrying out the invention is as follows. Preferably, the composition of the invention is present as a two-component composition in which secondary amine adduct component and amine diluent component is part of Component A and the polyisocyanate is part of Component B. Components A and B are applied, typically sprayed, to a substrate by employing conventional application equipment such as, for example, a plural component sprayer. Typically, Components A and B are mixed immediately prior to being applied. Subsequent to application to the substrate, the mixed composition of Components A and B rapidly cures generally according to the reaction scheme illustrated in the brief description of the drawings.

The foregoing examples are presented to illustrate the invention and are not intended to limit the scope of the invention as defined by the claims. All amounts listed in the examples are by weight, unless otherwise specified. The following list of resin components will be referred to in the examples: Resin A is polyaspartic esters based on hexamethylene diamine which is commercially available from Bayer MaterialScience LLC of 100 Bayer Road, Pittsburgh, Pa. as Desmophen NH1220. Resin A has an average molecular weight of 458 and an average amine hydrogen equivalent weight of 229. Resin B is a monofunctional amine. Resin B is commercially available from Huntsman International LLC, The Woodlands, Tex. 77387. As Jeffamine M-600. Resin B has a molecular weight of 600 and amine hydrogen equivalent weight of 300. Resin C an isocyanuratetrimer of hexamethylenediisocycanate which is commercially available from Bayer MaterialScience LLC of 100 Bayer Road, Pittsburgh, Pa. as Desmodur N 3900. Resin D is isophoronediisocyanate, which is commercially available as Desmodur I from Bayer MaterialScience LLC of 100 Bayer Road, Pittsburgh, Pa. Hardener #1 isocyanuratetrimer of hexamethylenediisocycanate, is commercially available from Bayer MaterialScience LLC of 100 Bayer Road, Pittsburgh, Pa. As Desmodur N 3300. Hardener #2 biuret of hexamethylenediisocyanate which is made by Evonik Industrys of Paul-Bau Mann Str, D45764, Mari, Germany, as Vestanat HB 2640 LV. Pigment A is titanium dioxide pigment, which is commercially available from Dupont of Wilmington, Del. as Ti-Pure® 902.

### Example 1

The secondary amine adduct #1 (SAA 1) was prepared by charging three moles of Resin A to a 3-necked round bottom flask containing a mechanical stirrer, thermometer and an addition funnel. To the stirred Resin A at 25 degree.C., under a nitrogen atmosphere was added portionwise one mole of the Resin C, so as to maintain a reaction temperature of 60 degree.C. or lower using ice water cooling bath if necessary. At the completion of Resin C addition, the reaction was maintained at 60 degree. C, until the —NCO content is less than 0.1%. 15% of the Resin B was charged to the reactor and mixed for 10-15 minutes, then poured into a container and sealed. The secondary amine adduct #1 has a viscosity of 3100 CPS at 60 degree.C, and amine hydrogen equivalent weight of 554.

### Example 2

The secondary amine adduct #2 (SAA 2) was prepared by charging two moles of Resin A to a 3-necked round bottom flask containing a mechanical stirrer, thermometer and an addition funnel. To the stirred Resin A at 25 degree.C., under a nitrogen atmosphere was added portionwise one mole of the Resin D, so as to maintain a reaction temperature of 60 degree.C. or lower using ice water cooling bath if necessary. At the completion of Resin D addition, the reaction was maintained at 60 degree.C, until the —NCO content is less than 0.1%. 10% of the Resin B was charged to the reactor and mixed for 10-15 minutes, then poured into a container and sealed. The secondary amine adduct #2 has a viscosity of 2560 CPS at 60 degree.C., and amine hydrogen equivalent weight of 521.

### Example 3

A pigment base was prepared by high-speed dispersing 50 parts of Pigment A in 50 parts of Resin A for 30 minutes until a Hegman Grind of 7 was obtained.

### Example 4

Component A of a fast curing traffic paint was prepared by blending 50 parts of pigment base from Example 3, 16.25 parts of Resin A, 33.75 parts of SAA 1 from Example 1. The cure speed and durability properties of the cured films based on Hardener #1 Desmodur N 3300 are set forth in Table 1.

### Example 5

Component A of a fast curing traffic paint was prepared by blending 50 parts of pigment base from Example 3, 12.5 parts of Resin A, 37.5 parts of SAA 2 from Example 2. The cure speed and durability properties of the cured films based on Hardener #1 Desmodur N 3300 are set forth in Table 1.

### Example 6

Component A of a commerce polyurea white paint based on the U.S. Pat. No. 6,369,189. The comparative cure speed and durability properties of the cured films based on Hardener #2 Vestanat HB 2640 LV are set forth in Table 1.

### Example 7

A plural component road-striping machine applied the paint compositions described in examples 5 and hardener #1. The two components were heated to 110-120.degree.F., and spray applied to a road surface using a 2:1 mix ratio and a top dressing of retroreflective glass beads. A no track time test was run by driving an automobile over the stripe after the stripe was applied. The stripe passed the no track test after 1:20 minutes curing time.

TABLE 1

| | polyurea | | |
|---|---|---|---|
| | control | Polyurea | Polyurea |
| Samples | | | |
| Part A | Example 6 | Example 4 | Example 5 |
| Part B | Hardener #2 | Hardener #1 | Hardener #1 |
| Mix Ratio, by Volume | 2A to 1B | 2A to 1B | 2A to 1B |
| Curing speed minutes | | | |
| Gel time | 4 | 50 sec | 1:30 |
| No track Time without | 7:30 | 1:30 | 1:50 |
| glass beads | | | |
| Through dry time | 15:00 | 2:30 | 3:30 |
| Tack Free time | 25:00 | 2:50 | 4:00 |
| Flexibility ¼″ | pass | pass | pass |
| Shore D hardness at | | | |
| 75 degree. F. | | | |
| 30 minutes | 10 | 68 | 75 |
| 1 hour | 30 | 75 | 77 |
| 5 hours | 52 | 76 | 78 |
| 24 hours | 65 | 78 | 80 |
| Shore D hardness at | | | |
| 32 degree. F. | | | |
| 30 minutes | 50 | 62 | 60 |
| 1 hour | 55 | 78 | 70 |
| 5 hours | 62 | 78 | 71 |
| 24 hours | 65 | 80 | 78 |
| Accelerated weathering | | | |
| QUV-A 340 | | | |
| Initial Yellowness Index | 1.21 | −0.32 | −0.43 |
| 250 hour Yellowness Index | 6.15 | 0.42 | 0.46 |
| 500 hour Yellowness Index | 8.93 | 0.87 | 0.89 |
| 1000 hour Yellowness Index | 12.9 | 1.35 | 1.39 |

Disclosed herein are typical preferred embodiments of the invention and, although specific terms are employed, they are used in a generic and descriptive sense only and not for purposes of limitation of the scope of the invention as defined by the claims.
Noomen, Arie; Applications of Michael Addition Chemistry in Coatings Technology, Progress in Organic Coatings, 32 (1997) 137-142.
Primeaux II, D. J., 100% Solids Aliphatic Spray Polyurea Elastomer Systems, Polyurethanes World Congress 1991, Sep. 24-26, 1991, pp. 473-477.
Abstract (Wicks&Yeske), Control of the Reaction Between Polyaspartic Esters and Aliphatic Polyisocyanates, Feb. 24-26, 1993, pp. 49-56.
Brochure, Texaco Chemical Company, Potential Uses for Polyurea Spray Elastomers, 1990.
Brochure, Texaco Chemical Company, Polyurea Spray Technology Information, 1989, pp. 1-5.
Http://stnessy.cas.org/tmp/282588-0319287490-200/711682533.html, Abstract, Ochi et al., Jpn. KokaiTokkyoKoho, 13 pp., Apr. 22, 2001.
Http://stnessy.cas.org/tmp/282588-0319287490-200/736074878.html, Abstract, Harper, Eur. Pat. Appl., 13 pp., Apr. 22, 2001.
   Composition of secondary amine adducts, amine diluents and polyisocyanates

That which is claimed:

1. A polymeric composition exhibiting a fast cure rate, said composition consisting essentially of:
a secondary amine adduct component having two or more secondary amine functionalities per molecule;
an amine diluent component;
and from about 20 to about 35 percent by weight of a polyisocyanate component;
wherein said secondary amine adduct component and an amine diluent to react with said polyisocyanate component that a chemically high crosslinked polymeric material is formed, and wherein said polymeric composition has a no track time of about 2 minutes.

2. The composition according to claim 1, wherein the secondary amine adduct component is a reaction product of a polyaspartic ester and an isocyanate.

3. The composition according to claim 1, wherein the secondary amine adduct component is a reaction product of a polyaspartic ester and an epoxy functional component.

4. The composition according to claim 2 and 3, wherein the polyaspartic ester is selected from the polyaspartic ester based on hexamethylene diamine, isophorone diamine, Bis(4-aminocyclohexyl)methane, and mixtures thereof.

5. The composition according to claim 2 and 3, wherein the polyaspartic ester contains at least two secondary amine groups.

6. The composition according to claim 2, wherein the isocyanate is selected from isophoronediisocyanate, 1,1′-methylenebis(4-isocyantocyclohexane), hexamethyenediisocyanate, trimethyl-hexamethylenediisocyanate, biuret of isophoronediisocyanate, isocyanuratetrimer of isophoronediisocyanate, biuret of hexamethylenediisocyanate, isocyanuratetrimer of hexamethylenediisocycanate, and mixtures thereof.

7. The composition according to claim 2, wherein the isocyanate contains at least two isocyanate functional groups.

8. The composition according to claim 3, wherein the epoxy functional component is selected from bisphenol A diglycidyl ether, ethylene glycol diglycidyl ether, Neopentyl glycol diglycidyl ether, trimethylopropane triglycidyl ether, trimethylolethane triglycidyl ether, and mixtures thereof.

9. The composition according to claim 3, wherein the epoxy functional component contains at least two 1, 2-epoxy groups per molecule.

10. The composition according to claim 1, wherein the amine diluent component is selected from the polyaspartic esters, polypropylene glycol monoamine, and mixtures thereof.

11. The composition according to claim 1, wherein the polyisocyanate is selected from the group consisting of isophoronediisocyanate, 1,1′-methylenebis(4-isocyantocyclohexane), hexamethyenediisocyanate, trimethyl-hexamethylenediisocyanate, biuret of isophoronediisocyanate, isocyanuratetrimer of isophoronediisocyanate, biuret of hexamethylenediisocyanate, isocyanuratetrimer of hexamethylenediisocycanate, and mixtures thereof.

12. The composition according to claim 1, wherein the polyisocyanate contains at least two isocyanate functional groups per molecule.

13. A traffic paint composition comprising the polymeric composition defined in claim 1 and at least one pigment.

14. The composition according to claim 13, wherein the secondary amine adduct component is a reaction product of a polyaspartic ester and an isocyanate.

15. The composition according to claim 14, wherein the polyaspartic ester is selected from the group consisting of the polyaspartic ester based on hexamethylene diamine, isophorone diamine, Bis(4-aminocyclohexyl)methane, and mixtures thereof.

16. The composition according to claim 14, wherein the polyaspartic ester is polyaspartic ester based on hexamethylene diamine.

17. The composition according to claim 14, wherein the isocyanate is selected from the group consisting of isophoronediisocyanate, 1,1′-methylenebis(4-isocyantocyclohexane), hexamethyenediisocyanate, trimethyl-hexamethylenediisocyanate, biuret of isophoronediisocyanate, isocyanuratetrimer of isophoronediisocyanate, biuret of hexamethylenediisocyanate, isocyanuratetrimer of hexamethylenediisocycanate, and mixtures thereof.

18. The composition according to claim 1, wherein the amine diluent component is selected from the polyaspartic esters, polypropylene glycol monoamine, and mixtures thereof.

19. The composition according to claim 1, wherein the polyisocyanate is selected from the group consisting of isophoronediisocyanate, 1,1′-methylenebis(4-isocyantocyclohexane), hexamethyenediisocyanate, trimethyl-hexamethylenediisocyanate, biuret of isophoronediisocyanate, isocyanuratetrimer of isophoronediisocyanate, biuret of hexamethylenediisocyanate, isocyanuratetrimer of hexamethylenediisocycanate, and mixtures thereof.

20. A polymeric composition exhibiting a fast cure rate, said composition consisting essentially of: a secondary amine adduct component formed from the reaction product of an aspartic ester based on hexamethylene diamine and an isocyanate; an amine diluent component; and from about 20 to about 35 percent by weight of a polyisocyanate component; wherein said secondary amine adduct component and said amine diluent component to react with said polyisocyanate component that a chemically high crosslinked polymeric material is formed, and wherein said polymeric composition has a no track time of less than about 2 minutes.
